(19) United States
(12) Patent Application Publication
(10) Pub. No.: US 2007/0043570 A1
(43) Pub. Date: Feb. 22, 2007

(54) Method of controlling a dialoging process

(75) Inventor: Holger Scholl, Herzogenrath (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V.

(21) Appl. No.: 10/564,699

(22) PCT Filed: Jul. 6, 2004
(86) PCT No.: PCT/IB04/51132

§ 371 Date: Oct. 9, 2006

(30) Foreign Application Priority Data
Jul. 18, 2003 (EP) 03102229.6

(51) Int. Cl. G10L 11/00

(52) U.S. Cl. 704/270.1

(57) ABSTRACT

A method of controlling a dialoging process is described in which a current situation parameter (sysp, mi, si) is automatically determined and in which the control of the dialoging process takes place as a function of the situation parameter (sysp, mi, si) in such a way that the dialoging process is adapted to the current situation.

The invention relates to a method of controlling a dialoging process, particularly in the context of a speech-controlled application, and to a corresponding dialoging system.

Recently, developments in the field of the man-machine interface have meant that the operation of technical devices is increasingly being performed by a dialog between the technical device and the user of the device. In this way, it is in particular known for a navigation system to be operated by having the navigation system address questions or commands to the user of the navigation system by the output of synthesized speech, and by having the user engage in a dialog with the navigation system by speaking commands or questions. Also known however are operating dialogs that are not based on speech. In this way, almost every mobile telephone is, for example, nowadays set by means of an operating dialog that is based on the display of options on a graphics display belonging to the mobile telephone, and on the selection of one of the options as a result of the appropriate key being pressed by the user.

Operating dialogs of this kind between man and machine bring with them the disadvantage that, unlike dialogs that are carried on between human beings, the process followed in them is always the same. For a long time, no provision was made for any adaptation to the surroundings or to the user. To overcome this disadvantage, approaches to a solution have now been conceived and even implemented in practice. In this way, there are known operating dialogs in which, in a first operating step, the user makes an input to say whether he is using the device being operated for the first time or whether he is already familiar with the way in which the device is operated. On the basis of this first input by the user, the continuation of the operating dialog is adapted to the experience the user has had, by for example at first not even offering the first-time user, for him to select, certain options that are not absolutely necessary for the operation of the device, but doing this for an experienced user. Another approach to a solution is oriented in an entirely different direction, namely to adapting only the dialog output to the surroundings. For this purpose, it is for example known for ambient noise to be determined and, as a part of an operating dialog, for the volume of a speech output to be adapted to the ambient noise in such a way that the volume of the output is high when the volume of the ambient noise is high, and vice-versa.

Although these known solutions considerably improve the operating dialog between man and machine, in practice they still do not give satisfactory results, particularly in comparison with a man-man dialog.

It is therefore an object of the present invention to specify a method of controlling a dialoging process that enables reliable communication to take place between a technical device and a user of the device.

This object is achieved by a method of the kind stated in the opening paragraph in which a current situation parameter is determined, and in which the control of the dialoging process takes place as a function of the situation parameter in such a way that the dialoging process is adapted to the current situation. The dependent claims relate in the respective cases to advantageous embodiments and refinements of the invention.

The invention is based in this case firstly on the idea of automatically sensing, continuously or at fixed or varying intervals of time, the current situation in which the dialog to be controlled is taking place. In particular, the dialoging process may be constantly adapted to the current situation. For this purpose, one or more situation parameters are determined that are characteristic of the current situation as far as the dialog to be controlled is concerned.

Depending on the dialog that is to be controlled or on the application in which the dialog to be controlled is taking place, there are an enormous variety of situation parameters that may be considered. Preferably however, it is one or more of the following situation parameters that are determined: locational information, location co-ordinates, time information, time of day, image information, audio information, video information, temperature information, lighting information (such as, for example, brightness of outside lighting), information on the surroundings (such as, for example, ambient noise), information on the user (such as, for example, blood pressure, pulse rate, rate of perspiration, how much the user is moving, etc.), speed information, driving situation information (such as, for example, acceleration information, inclination information, braking system information, steering system information, accelerator pedal information, brake anti-locking system information, ESP (electronic stability system) information, headlight information, traffic density, road surface characteristics, etc.) and/or social activity indicators (such as, for example, the number of other people in the surrounding area, amount of interaction).

In addition or as an alternative to these situation parameters, provision is preferably made for situation parameters to be formed by system parameters of the dialoging system itself or of a part of the dialoging system, such as, for example, those of a speech recognition system. In this way, the following speech recognition parameters too may be used as situation parameters: signal-to-noise ratio (SNR), speed of articulation, tonal or linguistic stress indicators, degrees of confidence achieved in the recognition, previous utterances by the user, number of the system's semantic concepts open at the same time in a dialoging process, proportion of expletives in the user's speech and/or speech-impact indicators (such as, for example, the number of hesitations, etc.). What is achieved in this way is that the current situation can be sensed at little additional cost and complication, because what is used as a situation parameter is a system parameter that is being generated anyway in the context of the dialoging process for other purposes.

As a function of the situation parameter or parameters that is/are sensed, the dialoging process is then controlled in such a way that it is adapted to the current situation. A dialoging process may, for example, be defined by dialog steps in this case. The dialog steps may comprise dialog input steps (input by the user to the dialoging system) and/or dialog output steps (output from the dialoging system to the user). The adaptation of the dialoging process may, for example, be performed by changing the dialog steps themselves. The change to a dialog step will preferably be implemented as a change in the amount and/or nature of the information output in a dialog step, and/or in the options. In addition or as an alternative to changing the dialog steps themselves, it is also possible for the dialoging process to be adapted by changing the sequence of the dialog steps or by changing the dialog steps that are selected from a possible maximum set of dialog steps. To simplify a dialoging process in, for example, critical operating situations, the number of options offered in the individual dialog output steps may be reduced, or only options that are easy to grasp or that are essential for operation in the situation concerned may be displayed, and/or the options offered may be shown in such a way that they are particularly easy for the user to grasp. In addition or as an alternative to this, the dialog output steps performed will preferably be only the ones that are essential for operation in the situation concerned.

The invention gives particular advantages if it is embedded in a speech-controlled application that comprises speech recognition and speech output. This is because it is precisely in this environment that a man-machine dialog is possible in the most varied situations and an adaptation to the current situation is particularly effective. In this way, a navigation system in a vehicle can, basically, be operated by speech both when the vehicle is stationary and while it is traveling along a freeway or motorway. However, travel along a freeway or motorway calls for greater attentiveness from the driver, and it is therefore advantageous for the dialoging process to be simplified in this situation. For this purpose, the language used in the dialog output steps may, for example, be simplified, by giving preference to the output of words whose meaning or sound is easy to understand, to defining options in a few words and/or to outputting questions that can be replied to by the user with simple answers such as “Yes” or “No”. In this case, the speech recognition that is applied to the dialog input steps, i.e. to the spoken commands by the user, is preferably adapted to the current situation by causing the recognition to require a higher degree of reliability in critical situations than in non-critical situations, in order to avoid any mis-operation. In addition or as an alternative to this, the speech recognition that is applied to the dialog input steps is adapted to the options that were output in the preceding dialog output step, which options had been adapted to the situation, by causing it to expect spoken input information corresponding to the output step. So if, as a consequence of the dialoging process being adapted in a critical operating situation, a question that expects the answer “Yes” or “No” is output in a dialog output step, the speech recognition system is controlled in such a way that it preferably checks the input that follows from the user to see whether “Yes” or “No” is said. When a speech control system is being used, what is preferably employed as a situation parameter is, in the way that has already been described above, a system parameter that characterizes the user's speech (a speech recognition parameter). For example, a high speed of articulation, speaking loudly, speech that is hard to understand and/or loud background noise may also be an indication of a critical situation.

A dialoging process in which automatic speech recognition is incorporated may, for example, be adapted to the current situation by causing the dialoging system to output a small vocabulary, short words and/or simple words in a critical situation and/or to use distinct, i.e. particularly clear, enunciation in such a situation. In addition or as an alternative to this, preference may be given in the output steps to outputting questions that require only a short answer. What was also found to be advantageous in preliminary investigations is for inputs detected by the speech recognition system that are particularly important in critical situations to be made subject to explicit verification by causing them to be output again for checking before they undergo any further processing. In non-critical or relaxed situations on the other hand, the speech recognition system or speech output can be switched to a conversational mode in which the user can communicate with the system using a larger vocabulary and in which user inputs are, for example, verified only implicitly in subsequent dialog steps. Also, in critical situations for example, an automatic switch can be made to a mode of operation determined by the system in which the system dictates the precise course of a dialoging process and no changes are possible to it. In more relaxed situations on the other hand, the system may run in what is termed a “mixed initiative” mode of operation in which the user can also make inputs not asked for by the system on his own initiative. Unprompted inputs of this kind are understood by the system and if required the dialoging process is altered accordingly. Changes in the mode of operation of this kind are, for example, possible by adjusting the number of semantic concepts that are open during a dialog. The number of semantic concepts that are open is preferably reduced in critical situations, or if required operations may even proceed with only one semantic concept open.

To enable a dialoging situation to be sensed as comprehensively as possible, and to enable a dialoging process to be adapted stably and in a practical manner to the situation that is sensed with little cost and complication, investigations involving considerable expenditure have shown it to be particularly advantageous for a current situation profile to be determined as part of a situation classification on the basis of the situation parameter or parameters determined, and for the adaptation of the dialoging process to the current situation to be carried out on the basis of the situation profile that is determined. When use is in a vehicle, what may be provided as situation profiles are, for example, a “critical driving situation” a “non-critical driving situation” and a “parking situation”. The situation profiles are preferably defined by applying logic “AND” or “OR” conditions respectively assigned to them to ranges of one or more situation parameters. In this way, a “critical driving situation” for example is found to exist if the speed is more than 100 km/h OR the level of acceleration is higher than a preset threshold level for acceleration. A “non-critical driving situation” is preferably found to exist if the speed is less than 100 km/h AND if the ambient noises are quiet. The “parking situation” can typically be defined by an engine that is switched off.

In addition or as an alternative to the “discrete” adaptation of the dialoging process to the current situation that has been described above (mapping of the current situation onto discrete situation profiles), provision is preferably made for a “continuous” adaptation of the dialoging process to the current situation (mapping of the current situation onto a continuous situation-related value), in which, when there are small changes in the current situation, the dialoging process too is changed only in steps of any desired small size. For thus purpose, a current situation-related value that characterizes the current situation is determined from the situation parameter or parameters, by mathematical mapping for example. Preferably, the mathematical mapping is so defined in this case that the result is that a high situation-related value stands for a critical situation, whereas a low situation-related value stands for a non-critical situation. The speed of the synthesized speech that is output by a vehicle navigation system may, for example, be reduced linearly with the increase in the speed of the vehicle. What is used as a situation-related value in this case is only the speed of the vehicle. The result of combining the “discrete” adaptation with the “continuous” adaptation is an unsharp classification of situations that is particularly stable and user-friendly.

As a particular preference, provision is made for the dialoging process to be changed as a function of whether the situation that exists is a private one or, in contrast to this, a public one. A private situation may, for example, exist when the ambient noise is quiet whereas a public situation exists when the ambient noise is loud. Authentication of the user in a private situation, such as at home for example, may for example take place as part of a dialog step by the explicit uttering of a secret number. So that no private information has to be uttered in the course of a dialoging process in a public situation, such as, for example, on a bus or in a queue waiting to use a cash machine, the dialoging process is controlled in such a way that only a non-spoken input via a PIN pad or the like is asked for.

The invention also covers a dialoging system having a dialog input/output interface, having a situation parameter interface, and having a dialog controlling means that is so arranged that a current situation parameter is determined automatically and that the control of a dialoging process is performed in such a way, as a function of the situation parameter, that the dialoging process is adapted to the current situation. Via the situation parameter interface, the dialoging system may be connected in this case particularly to situation sensing means, such as, for example, sensor means or measuring means of various kinds. The dialoging system is preferably connected via the dialog input/output interface to an input means, such as, for example, a microphone or a keyboard, and/or to an output means, such as, for example, a loudspeaker or a display device. To prevent the dialoging system from having to process raw sensor data, further signal processing means or information treating means are provided between the interfaces and the situation sensing means or input/output means.

The invention also covers dialoging systems that are embodied as in the claims dependent on the method claim.

These and other aspects of the invention are apparent from and will be elucidated with reference to the embodiments described hereinafter.

In the drawings:

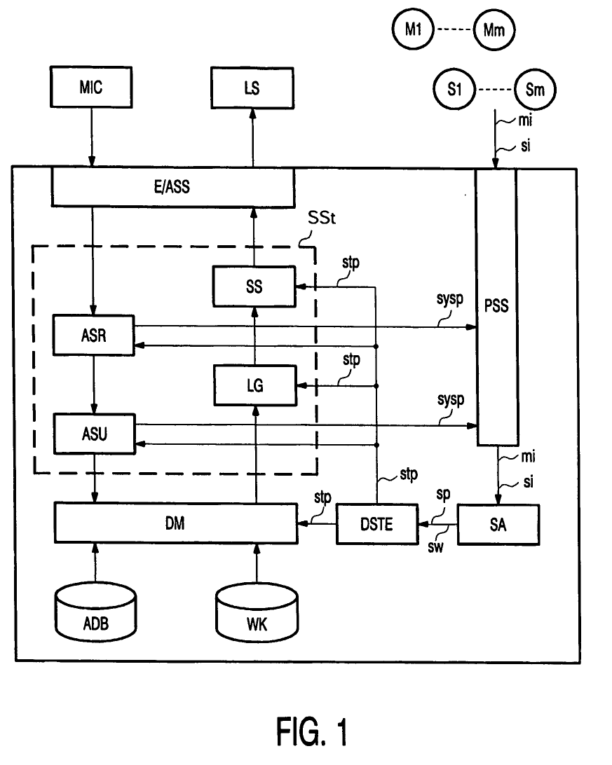

FIG. 1 is a simplified general arrangement drawing of a dialoging system.

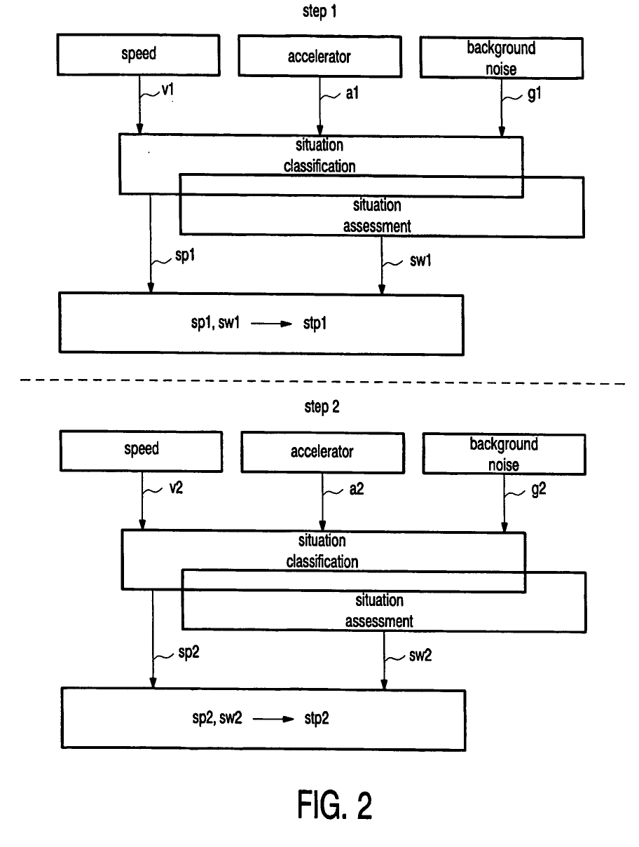

FIG. 2 is a schematic representation of steps in a method of controlling a dialoging system.

To make things clearer, only the essential components of, in particular, the hardware configuration of the system has been shown in FIG. 1. It is clear that this system may also have all the other components that normally form part of dialoging systems, such as, for example, suitable connecting lines, amplifier means, controls or a display means.

FIG. 1 shows, as part of a dialoging system DS, a situation parameter interface PSS, via which the dialoging system DS is connected to sensor means S1 . . . Sn and measuring means M1 . . . Mm. The dialoging system DS is also connected via an input/output interface E/ASS to a loudspeaker LS and a microphone MIC. The dialoging system DS also has a situation assessing unit SA. To the situation assessing unit SA is fed the sensor data si from the sensor means S1 . . . Sn and the measurement data mi from the measuring means M1 . . . Mn, which data is incoming via the situation parameter interface PSS. Also fed to the situation assessing unit SA are speech recognition system parameters sysp, which are determined anyway as intermediate or final results as part of a speech control process.

On the basis of the situation parameters that have currently been determined (sensor data si, measurement data mi, speech recognition system parameters sysp), the current situation profile sp and in addition, for a more accurate assessment, a current situation-related value sw, are determined in the situation assessing unit SA and are passed on to a dialog controlling means DSTE that forms the heart of the dialoging system DS. Control parameters stp are then determined in the dialog controlling means DSTE on the basis of the situation profile that has been determined and/or the situation-related value that has been determined. The control parameters stp are passed on both to a dialog manager DM and also to the individual parts of a speech control system SSt. The speech control system SSt is implemented in this case by means of an automatic speech recognition unit ASR, a speech interpretation unit ASU, a language generating unit LG and a speech synthesizing means SS. Via the input/output interface E/ASS, the speech synthesizing means SS is connected to the loudspeaker LS and the speech recognition unit ASR to the microphone MIC. The dialog manager organizes mainly the dialoging process, such as, for example, the selection and sequence of the input and output steps. As a result of the control parameters stp acting on the dialog manager DM, the dialoging process is adapted to the current situation. In addition to this, the dialoging process is also adapted to the current situation by the effects that the control parameters stp have on the parts ASR, ASU, LG and SS of the speech control system SSt.

The dialog manager DM, the dialog controlling means DSTE and/or the situation assessing means SA in particular may be formed, individually or together, by one or more program-controlled computer units and other circuit arrangements provided specifically for this purpose, whose programming is designed to perform the method according to the invention. For this purpose, the computer unit or units may be equipped with a processor means and a memory means. In the memory means may be stored not only the program data but also the definitions of various situation profiles sp and situation-related values sw and their mapping onto control parameters stp. Settings of the dialoging system DS that are made by the user of the dialoging system DS may also be stored in the storage means. As a supplement to this, information that is used to control the dialoging process or to interpret spoken inputs by the user may also be stored in databases provided specifically for this purpose, such as, for example, an application database ADB and a knowledge database WK, both of which the dialog manager DM may access.

There may also be provided in this case, as a part of this computer unit or units or separately therefrom, other information-processing means that for example preprocess the measured values mi, the sensor data si or the speech recognition system parameters sysp or apply further processing to the control parameters stp.

By reference to FIG. 2, there will now be elucidated an illustrative course followed by a method by which the dialoging process of a speech-controlled vehicle navigation system is adapted to the current situation.

At the beginning, let the vehicle be situated in the acceleration lane of a freeway or motorway. In a first step, to give situation parameters, the speed v1 of the vehicle is measured, the acceleration a1 of the vehicle is sensed by an acceleration sensor, and the background noise g1 is determined as a speech recognition system parameter as part of the speech recognition process. These situation parameters v1, a1, g1 are fed to the situation assessing unit. Because of the high speed v1 of the vehicle, the high acceleration a1 and the loud engine noise g1, a critical situation is found to exist as a situation profile sp1. Also, from the three incoming situation parameters v1, a1, g1, a high situation-related value sw1 is determined that reflects the fact that all three of the situation parameters v1, a1, g1 are themselves particularly high for a critical situation.

The situation profile sp1 and the situation-related value sw1 are then mapped onto a control parameter stp1 or a set of control parameters, which is/are then fed to the dialog manager and the speech recognition system. As a result of the control parameter stp1 being processed in the dialog manager and the speech recognition system, the dialoging process is adapted to the current situation. Because of the critical situation that has been found to exist, the dialog between the navigation system and the user for example is set in such a way that the navigation system outputs only easily comprehensible information to which the user can respond by uttering the words “Yes” or “No”.

In a second step, let the vehicle be situated in a quiet parking space with the engine switched off. Once again, to give situation parameters, the speed v2 is measured, the acceleration a2 is sensed, and the background noise g2 is determined as a speech recognition system parameter. The situation parameters v2, a2, g2 are once again fed to the situation assessing unit and what is now found to exist is an non-critical situation or even a “Parking situation”. Also, a low situation-related value sw2, which reflects the fact that the vehicle is not only standing still but is also doing so in particularly quiet surroundings, is determined from the three incoming situation parameters v2, a2, g2.

The situation profile sp2 and the situation-related value sw2 are then once again mapped onto a control parameter, stp2 in this case, or a set of control parameters, which is/are then fed to the dialog manager and the speech recognition system. As a result of the control parameter stp2 being processed in the dialog manager and the speech recognition system, the dialoging process is once again adapted to the current situation. Because of the “Parking situation” that has been found to exist, the dialog between the navigation system and the user for example is set in such a way that, as part of a dialoging process, the navigation system even outputs information that is relatively difficult to understand and that conveys a relatively complex message, to which the user responds even with answers whose meaning is more involved than a simple “Yes” or “No”.

Finally, it will again be pointed out that the systems and methods that are shown in the Figures and described in the description are merely illustrative embodiments that can be varied to a wide extent by the man skilled in the art without thereby exceeding the scope of the invention. In this way, a dialoging system that includes automatic speech recognition was described by reference to the Figures. In addition or as an alternative to this, the dialoging system may however also include a display means, such as a graphic display, and controls, such as a keyboard or a touch-screen. A dialoging system according to the invention may also be incorporated in a mobile telephone, an electronic notebook, a portable electronic device used for home entertainment, such as an audio/video player for example, or in a household appliance such as a washing machine or a cooker, or in an automatic teller machine.

For the sake of completeness, it should also be pointed out that the use of the indefinite article “a” or “an” does not rule out the possibility of the feature concerned being present more than once and the use of the term “comprise” does not rule out the possibility of there being other items or steps.

1. A method of controlling a dialoging process in which
a current situation parameter is automatically determined and
the control of the dialoging process takes place as a function of the situation parameter in such a way that the dialoging process is adapted to the current situation.

2. A method as claimed in claim 1, characterized in that the dialoging process is embedded in the framework of a speech-controlled application and in that an automatic speech recognition unit is used in the dialoging process.

3. A method as claimed in claim 1, characterized in that a speech synthesizing means is used in the dialoging process.

4. A method as claimed in claim 1, characterized in that a current situation profile is determined on the basis of the situation parameter determined and in that the control of the dialoging process takes place as a function of situation profile in such a way that the dialoging process is adapted to the current situation.

5. A method as claimed in claim 4, characterized in that various situation profiles are assigned to various ranges of situation parameters and in that what is determined as the current situation profile is that situation profile that is assigned to the range of situation parameters in which the situation parameter determined lies.

6. A method as claimed in claim 1, characterized in that a current situation-related value is determined from the situation parameter determined and in that the control of the dialoging process takes place as a function of the situation-related value in such a way that the dialoging process is adapted to the current situation.

7. A method as claimed in claim 1, characterized in that what is used as a situation parameter is a system parameter that is generated anyway in the context of the dialoging process for some other purpose.

8. A method as claimed in claim 7, characterized in that a speech recognition system parameter that is generated as part of automatic speech recognition is used as a situation parameter.

9. A method as claimed in claim 1, characterized in that the control of the dialoging process takes place as a function of a situation parameter in such a way that user authentication in a private situation calls for the input of a user data object in a way in which the input is not required in a public situation.

10. A dialoging system having a dialog input/output interface, a situation parameter interface, and a dialog controlling means that is so arranged that:
a current situation parameter is automatically determined and
the control of the dialoging process takes place as a function of the situation parameter in such a way that the dialoging process is adapted to the current situation.

11. A dialoging system as claimed in claim 10, characterized by a sensor means connected to the situation parameter interface and/or a measuring means connected to the situation parameter interface, for determining sensor data and measurement data respectively.
